(19) United States
(12) Patent Application Publication
(10) Pub. No.: US 2026/0201805 A1
(43) Pub. Date: Jul. 16, 2026

(54) SHAPE MEMORY ALLOY UNDER-ROOT FAN BLADE SPACER

(71) Applicant: RTX Corporation, Farmington, CT (US)

(72) Inventors: Jackson David Johnson, Lanexa, KS (US); Colin Kling, Exton, PA (US)

(73) Assignee: RTX Corporation, Farmington, CT (US)

(21) Appl. No.: 19/021,886

(22) Filed: Jan. 15, 2025

(51) Int. Cl. F04D 29/26; F04D 29/60

(52) U.S. Cl. CPC F01D 5/326; F01D 5/3092; F04D 29/26; F04D 29/601; F05D 2220/36; F05D 2300/17; F05D 2300/505

(57) ABSTRACT

An under-root fan blade spacer system including a fan hub including a fan hub receiver, the fan hub receiver having a hub receiver floor, the fan hub receiver having an opening configured to receive a fan blade root, the fan blade root includes a base end; a gap formed between the base end of the fan blade root and a hub receiver floor; and a spacer disposable within the gap, the spacer comprising a shape memory alloy material.

### BACKGROUND

The present disclosure is directed to the improved under-root fan blade spacer.

Under-root fan blade spacers are required to lock blades in place when the fan blade is windmilling and during assembly. If a bird impacts the fan blades, the fan blade may move into the volume occupied by the under-root spacer creating competing objectives. Additionally, for larger fan blades, current under-root fan blade spacer designs either do not adequately hold the fan blade in place during windmilling or require unacceptably large forces to install.

### SUMMARY

In accordance with the present disclosure, there is provided an under-root fan blade spacer system comprising a fan hub including a fan hub receiver, the fan hub receiver having a hub receiver floor, the fan hub receiver having an opening configured to receive a fan blade root, the fan blade root includes a base end; a gap formed between the base end of the fan blade root and a hub receiver floor; and a spacer disposable within the gap, the spacer comprising a shape memory alloy material.

A further embodiment of any of the foregoing embodiments may additionally and/or alternatively include the spacer shape memory alloy material comprises properties with the capacity to deform under mechanical forces from an original shape and hold a deformed shape; and a capacity to regain the original shape upon being heated.

A further embodiment of any of the foregoing embodiments may additionally and/or alternatively include the spacer is configured as the original shape comprising a circular shaped tube and responsive to exposure to mechanical forces, the original shape being configured to change shape into the deformed shape comprising an ellipse shaped tube, and responsive to being heated, the spacer is configured to return to the original shape.

A further embodiment of any of the foregoing embodiments may additionally and/or alternatively include the spacer is configured to exert a force against the root base end and press the fan blade root against the fan hub receiver.

A further embodiment of any of the foregoing embodiments may additionally and/or alternatively include the spacer is configured to obtain a deformed shape responsive to being compressed, the spacer configured to at least one of insert into or extract from the gap between the fan blade root and the fan hub receiver.

A further embodiment of any of the foregoing embodiments may additionally and/or alternatively include the under-root fan blade spacer system further comprising a retaining feature formed in at least one of the root base end and the hub receiver floor, wherein the retaining feature is configured as a space to nest the spacer and prevent the spacer from relocating within the gap.

A further embodiment of any of the foregoing embodiments may additionally and/or alternatively include the spacer is located in a predetermined location by use of retaining features.

In accordance with the present disclosure, there is provided a gas turbine engine under-root fan blade spacer system comprising a fan hub including a fan hub receiver, the fan hub receiver having a hub receiver floor, the fan hub receiver having a dovetail shaped opening configured to receive a fan blade root, the fan blade root includes a base end; a gap formed between the base end of the fan blade root and a hub receiver floor; and at least one spacer disposable within the gap, the at least one spacer comprising a shape memory alloy material.

A further embodiment of any of the foregoing embodiments may additionally and/or alternatively include the at least one spacer shape memory alloy material comprises properties with the capacity to deform under mechanical forces from an original shape and hold a deformed shape; and a capacity to regain the original shape upon being heated.

A further embodiment of any of the foregoing embodiments may additionally and/or alternatively include the at least one spacer is configured to obtain a deformed shape responsive to being compressed, the at least one spacer configured to at least one of insert into or extract from the gap between the fan blade root and the fan hub receiver.

A further embodiment of any of the foregoing embodiments may additionally and/or alternatively include the gas turbine engine under-root fan blade spacer further comprising a retaining feature formed in at least one of the root base end and the hub receiver floor, wherein the retaining feature is configured as a space to nest the at least one spacer and prevent the at least one spacer from relocating within the gap.

A further embodiment of any of the foregoing embodiments may additionally and/or alternatively include the gas turbine engine under-root fan blade spacer further comprising a coating disposed over an outside diameter of the at least one spacer.

A further embodiment of any of the foregoing embodiments may additionally and/or alternatively include the gas turbine engine under-root fan blade spacer further comprising an encapsulation envelope configured to contain the at least one spacer.

In accordance with the present disclosure, there is provided a process of forming an under-root fan blade spacer system comprising forming a fan hub including a fan hub receiver, the fan hub receiver having a hub receiver floor, the fan hub receiver having an opening configured to receive a fan blade root, the fan blade root includes a base end; forming a gap between the base end of the fan blade root and a hub receiver floor; and disposing at least one spacer within the gap, the at least one spacer comprising a shape memory alloy material.

A further embodiment of any of the foregoing embodiments may additionally and/or alternatively include the process further comprising configuring the at least one spacer shape memory alloy material comprising properties with the capacity to deform under mechanical forces from an original shape and hold a deformed shape; and a capacity to regain the original shape upon being heated.

A further embodiment of any of the foregoing embodiments may additionally and/or alternatively include the process further comprising configuring the at least one spacer to obtain a deformed shape responsive to being compressed; and configuring the at least one spacer to at least one of insert into or extract from the gap between the fan blade root and the fan hub receiver.

A further embodiment of any of the foregoing embodiments may additionally and/or alternatively include the process further comprising forming a retaining feature in at least one of the root base end and the hub receiver floor; and configuring the retaining feature as a space to nest the at least one spacer and prevent the at least one spacer from relocating within the gap.

A further embodiment of any of the foregoing embodiments may additionally and/or alternatively include the process further comprising disposing a coating over an outside diameter of the at least one spacer.

A further embodiment of any of the foregoing embodiments may additionally and/or alternatively include the process further comprising forming an encapsulation envelope to contain the at least one spacer.

A further embodiment of any of the foregoing embodiments may additionally and/or alternatively include the process further comprising locating the at least one spacer in a predetermined location by use of at least one retaining feature.

Other details of the under-root fan blade spacer are set forth in the following detailed description and the accompanying drawings wherein like reference numerals depict like elements.

### BRIEF DESCRIPTION OF THE DRAWINGS

The above and further advantages of this disclosure may be better understood by referring to the following description in conjunction with the accompanying drawings, in which like reference numerals indicate like elements and features in the various figures. Letters may be appended to reference numbers to distinguish from reference numbers for similar features and to indicate a correspondence to other features in the drawings. For clarity, not every element may be labeled in every figure. The drawings are not necessarily to scale, emphasis instead being placed upon illustrating the principles of the disclosure.

FIG. 1 is a schematic representation of an exemplary under-root fan blade spacer system.

FIG. 2 is a schematic representation of an exemplary under-root fan blade spacer system.

FIG. 3 is a schematic representation of an exemplary under-root fan blade spacer system.

FIG. 4 is a schematic representation of an exemplary under-root fan blade spacer system.

### DETAILED DESCRIPTION

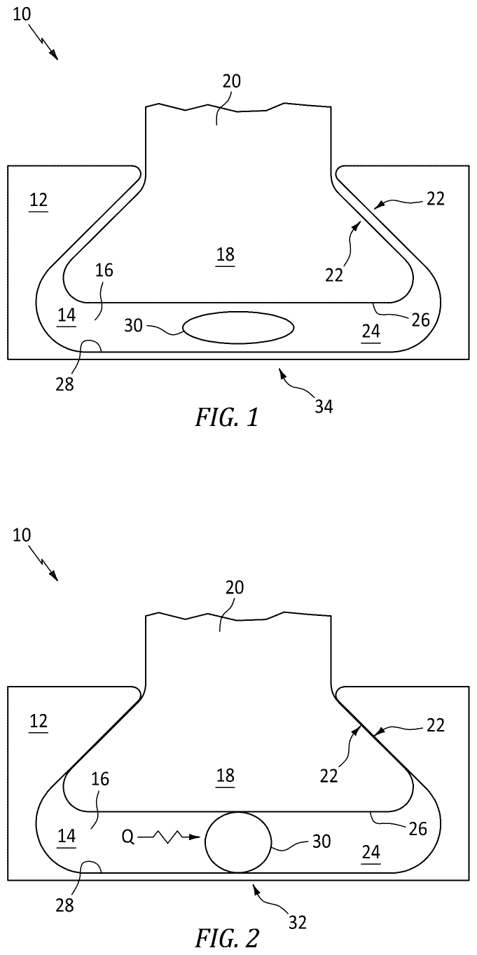

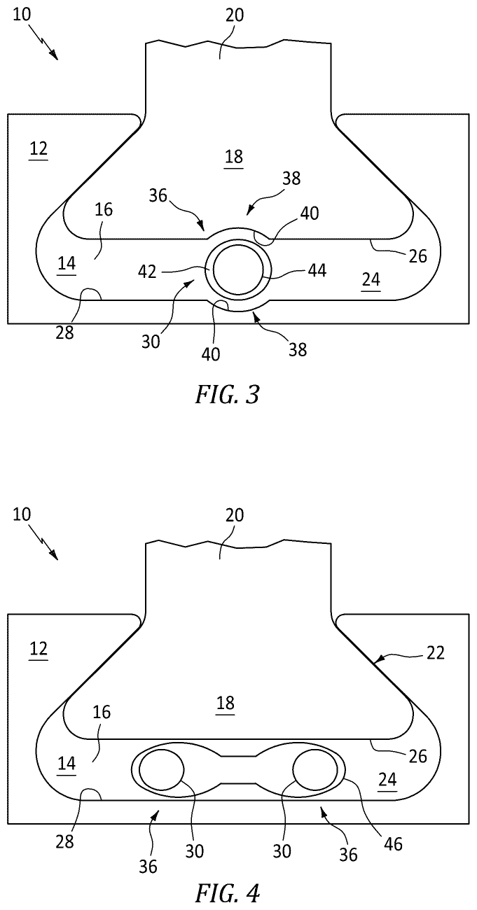

Referring now to FIG. 1, FIG. 2, FIG. 3 and FIG. 4, showing an exemplary under-root fan blade spacer system 10. The under-root fan blade spacer system 10 includes a fan hub 12. The fan hub 12 includes a fan hub receiver 14. The fan hub receiver 14 includes a dovetail shaped opening 16 configured to receive a root 18 of a fan blade 20. The root 18 of the fan blade 20 has a corresponding shape to interface with the dovetail shaped opening 16. The dovetail shaped opening 16 and the fan blade root 18 include tapered walls 22 that interlock to secure the fan blade 20 within the fan hub receiver 14, as shown in FIG. 2 and FIG. 3.

The fan blade root 18 is sized to be smaller than the fan hub receiver 14. A gap 24 is formed between a base end 26 of the fan blade root 18 and a hub receiver floor 28. The gap 24 can vary in size responsive to movement and relative position of the fan blade root 18 within the fan hub receiver 14.

An under-root fan blade spacer or simply spacer 30 can be positioned between the fan blade root 18 and the fan hub receiver 14. The spacer 30 can be configured to support the fan blade 20 within the fan hub receiver 14. The spacer 30 can be configured pliable and resilient. The spacer 30 can be configured to exert a force against the root base end 26 and press the fan blade root 18 against the fan hub receiver 14. The spacer 30 can bias the fan blade root 18 such that the slanted walls 22 of the fan hub receiver 14 and the fan blade root 18 maintain contact as shown in FIG. 2, FIG. 3 and FIG. 4.

As seen in FIG. 1, the spacer 30 is compressed in shape to accommodate the relatively smaller gap 24 size in order to be installed within the gap 24. The spacer 30 can be deformed or otherwise change shape, such as the ellipse shape shown in FIG. 1. The spacer 30 can regain an original shape 32 from the deformed shape 34. The original shape 32 can be sized to snugly fit between the root base end 26 and the hub receiver floor 28.

The spacer 30 can be manufactured from shape memory alloy materials that allow for deformation from the original shape 32 to a deformed shape 34 and rebound back into the original shape 32. The spacer 30 can be constructed from the shape memory alloy such as Nitinol.

The memory alloy can provide two material properties that give the spacer 30 the unique attributes. The first property is the capacity to deform under mechanical forces from the original shape 32 and hold the deformed shape 34. The second property is the capacity to regain the original shape 32 upon being heated. The spacer 30 can be manufactured into the original shape 32, such as a hoop or circular shape and upon exposure to mechanical forces, squeezed into the deformed shape 34, such as the ellipse shape shown. The properties of the memory alloy enable the spacer 30 to reobtain the original shape 32 responsive to thermal energy input.

For example, the spacer 30 can be formed into a tube with a relatively circular hoop shape cross-section during original shape 32 formation. Then, the spacer 30 can be squeezed into an ellipse shape cross-section deformed shape 32. The spacer 30 can be installed into the gap 24 between the fan blade root 18 and the fan hub receiver 14 as shown. Because the spacer 30 is configured as the deformed shape 34, the spacer 30 can be installed without pressing the fan blade 18 against the fan hub 12.

There is little to no contact forces between the slanted walls 22 during installation, avoiding the need for large installation forces to place the spacer 30 in the gap 24. Next, thermal energy Q can be applied to the spacer 30. The spacer 30 can respond to the addition of the thermal energy Q and change shape to return to the original shape 32. As the spacer 30 returns to the original shape 32, the spacer 32 biases the fan blade 20 into a snug fit within the fan hub 12, so that the slanted walls 22 contact each other, as seen in FIG. 2. If disassembly is needed, the spacer can once again be deformed mechanically, into the deformed shape 34 and removed without the need for high forces to press the fan blade 20 into the fan hub 12. The load needed to remove the spacer 30 from the gap 24 can be near zero.

The spacer 30 can be deformed at room temperature. The spacer 30 can be heated to return the original shape 32 with a temperature of about 100 degrees Fahrenheit.

The spacer 30 can be formed as a tube with an open central diameter as shown in cross-section. The spacer 30 upon being reshaped to the original shape 32 can accommodate reactive forces from the blade root 18 and deflect to allow for the fan blade 20 to move within the fan hub 12 under predetermined conditions. An example of operating conditions that can influence the fan blade 20 and cause the spacer 30 to deflect can be a bird strike impacting the fan blade 20. The spacer 30 can be crushed in reaction to the fan blade 20 deflection caused by the bird impact. The fan blade root 18 can move within the fan hub receiver 14 without stress to the fan blade 20. When the engine operating temperature is high enough, the spacer 30 can regain the original shape 32 and revert back into the position as assembled stabilizing the impacted fan blade 20.

The spacer 30 can bias the fan blade 20 into a snug fit with the fan hub 12 during certain gas turbine engine conditions, such as windmilling. The spacer 30 can also be relied upon to keep the fan blade 20 in the correct location during gas turbine engine assembly.

Referring also to FIG. 3, the exemplary under-root fan blade spacer system 10 is shown with a modification to the fan blade 20 and fan hub 12. The spacer 30 can be located in a predetermined location 36 by use of retaining features 38. The retaining features 38 can be formed in the root base end 26, the hub receiver floor 28 and combinations thereof. The retaining feature 38 can be a groove or channel shaped depression in the surface 40 of the root base end 26 and/or hub receiver floor 28. The retaining feature 38 can have a similar silhouette to the shape of the spacer 30. For example, the retaining feature 38 is shown as a semicircle shape complementary to the circular shape of the spacer 30. The retaining feature 38 provides a space to nest the spacer 30 and prevent the spacer 30 from relocating within the gap 24. The retaining feature 38 maintains the spacer 30 in the predetermined location 36.

Referring also to FIG. 3 and FIG. 4, the exemplary under-root fan blade spacer system 10 is shown with a modification to the spacer 30. A coating 42 can be disposed over the spacer 30. The coating 42 can be applied to a spacer outside diameter 44. The coating 42 can reduce unwanted wear or degradation of the spacer 30, blade 18, and hub 12.

It is contemplated that more than one spacer 30 can be employed. The exemplary embodiment of FIG. 4 shows two spacers 30. The use of two spacers 30 allows for designed support of the fan blade 20 and two predetermined locations 36.

As seen in FIG. 4, an encapsulation envelope 46 can be employed with the exemplary under-root fan blade spacer system 10. The encapsulation envelope 46 can be configured to contain at least one spacer 30. The encapsulation envelope 46 can be constructed of flexible resilient materials, such as an over-molded polymer/elastomer. The encapsulation envelope 46 can be configured to maintain the spacer(s) 30 in the predetermined location 36 as well as provide durability preventing unwanted wear on the spacer 30, blade 18, and hub 12. The encapsulation envelope 46 can include a material with a lower hardness, elastic properties along with some rigidity.

A technical advantage of the disclosed under-root fan blade spacer system includes the use of the spacer constructed from a shape memory alloy tube capable of being inserted under the fan blade as a loose fit, then being heated to seat the fan blade.

Another technical advantage of the disclosed under-root fan blade spacer system includes a system with assembly forces near zero, with the capacity to tightly hold the blade during windmilling.

Another technical advantage of the disclosed under-root fan blade spacer system includes the capacity during disassembly for a tool to be inserted into contact with the spacer which presses down the shape memory alloy tube that plastically deforms the tube into an ellipse, reducing the load to remove the spacer to near zero.

Another technical advantage of the disclosed under-root fan blade spacer system includes the capacity during a bird impact, for the shape memory alloy to crush, leaving more room for the fan blade root dovetail to move, reducing stress then, as the engine operating temperature is high enough, the shape memory alloy reverts to an original shape position, stabilizing the impacted fan blade again.

There has been provided a under-root fan blade spacer. While the under-root fan blade spacer has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. An under-root fan blade spacer system comprising:
a fan hub including a fan hub receiver, the fan hub receiver having a hub receiver floor, the fan hub receiver having an opening configured to receive a fan blade root, the fan blade root includes a base end;
a gap formed between the base end of the fan blade root and the hub receiver floor;
a spacer disposable within the gap, the spacer comprising a shape memory alloy material; and
a retaining feature formed in the root base end having a similar silhouette to a shape of the spacer.

2. The under-root fan blade spacer system according to claim 1, wherein the spacer shape memory alloy material comprises properties with a capacity to deform under mechanical forces from an original shape and hold a deformed shape and a capacity to regain the original shape upon being heated.

3. The under-root fan blade spacer system according to claim 2, wherein the spacer is configured as the original shape comprising a circular shaped tube configured to change shape into the deformed shape comprising an ellipse shaped tube, and the spacer includes structural material properties configured to return to the original shape.

4. The under-root fan blade spacer system according to claim 1, wherein the spacer exert a force against the root base end and press the fan blade root against the fan hub receiver.

5. The under-root fan blade spacer system according to claim 1, wherein the spacer is configured to obtain a deformed shape responsive to being compressed, the spacer configured to at least one of insert into or extract from the gap between the fan blade root and the fan hub receiver.

6. The under-root fan blade spacer system according to claim 1, further comprising:
another retaining feature formed in the hub receiver floor, wherein the another retaining feature is configured as a space to nest the spacer and prevent the spacer from relocating within the gap.

7. The under-root fan blade spacer system according to claim 1, wherein the spacer is located in a predetermined location by use of a retaining feature.

8. A gas turbine engine under-root fan blade spacer system comprising:
a fan hub including a fan hub receiver, the fan hub receiver having a hub receiver floor, the fan hub receiver having a dovetail shaped opening configured to receive a fan blade root, the fan blade root includes a base end;
a gap formed between the base end of the fan blade root and a hub receiver floor;
at least one spacer disposable within the gap, the at least one spacer comprising a shape memory alloy material; and
a retaining feature formed in the root base end having a similar silhouette to a shape of the at least one spacer.

9. The gas turbine engine under-root fan blade spacer according to claim 8, wherein the at least one spacer shape memory alloy material comprises properties with a capacity to deform under mechanical forces from an original shape and hold a deformed shape and a capacity to regain the original shape upon being heated.

10. The gas turbine engine under-root fan blade spacer according to claim 8, wherein the at least one spacer is configured to obtain a deformed shape responsive to being compressed, the at least one spacer configured to at least one of insert into or extract from the gap between the fan blade root and the fan hub receiver.

11. The gas turbine engine under-root fan blade spacer according to claim 8, further comprising:
another retaining feature formed in the hub receiver floor, wherein the another retaining feature is configured as a space to nest the at least one spacer and prevent the at least one spacer from relocating within the gap.

12. The gas turbine engine under-root fan blade spacer according to claim 8, further comprising:
a coating disposed over an outside diameter of the at least one spacer.

13. The gas turbine engine under-root fan blade spacer according to claim 8, further comprising:
an encapsulation envelope configured to contain the at least one spacer.

14. A process of forming an under-root fan blade spacer system comprising:
forming a fan hub including a fan hub receiver, the fan hub receiver having a hub receiver floor, the fan hub receiver having an opening configured to receive a fan blade root, the fan blade root includes a base end;
forming a gap between the base end of the fan blade root and a hub receiver floor;
disposing at least one spacer within the gap, the at least one spacer comprising a shape memory alloy material; and
forming a retaining feature in the root base end having a similar silhouette to a shape of the at least one spacer.

15. The process of claim 14, further comprising:
configuring the at least one spacer shape memory alloy material comprising properties with the capacity to deform under mechanical forces from an original shape and hold a deformed shape and a capacity to regain the original shape upon being heated.

16. The process of claim 14, further comprising:
configuring the at least one spacer to obtain a deformed shape responsive to being compressed; and
configuring the at least one spacer to at least one of insert into or extract from the gap between the fan blade root and the fan hub receiver.

17. The process of claim 14, further comprising:
forming another retaining feature in the hub receiver floor; and
configuring the another retaining feature as a space to nest the at least one spacer and prevent the at least one spacer from relocating within the gap.

18. The process of claim 14, further comprising:
disposing a coating over an outside diameter of the at least one spacer.

19. The process of claim 14, further comprising:
forming an encapsulation envelope to contain the at least one spacer.

20. The process of claim 14, further comprising:
locating the at least one spacer in a predetermined location by use of a retaining feature.
